(19) United States
(12) Patent Application Publication
(10) Pub. No.: US 2014/0230150 A1
(43) Pub. Date: Aug. 21, 2014

(54) CRANIAL SUPPORT CUSHION

(71) Applicant: KENT J. DELLENBUSCH, Altadena, CA (US)

(72) Inventor: KENT J. DELLENBUSCH, Altadena, CA (US)

(21) Appl. No.: 13/771,037

(22) Filed: Feb. 19, 2013

(51) Int. Cl. A61G 13/12

(52) U.S. Cl. CPC A61G 13/121
USPC 5/639; 29/428

(57) ABSTRACT

A cranial support cushion configured with a pillow and one or more devices for retaining cables, wires or connectors to instruments. The cranial support cushion is further directed to preventing tilting movement of a patient's head while isolating instrumentation cabling away from the patient resting supine or prone on a surgical table or gurney in a hospital operating room or a patient-monitoring arena. The cranial support cushion may be particularly designed for organizing the cabling leading from or to instrumentation used by an anesthesiologist or other healthcare provider.

### BACKGROUND OF THE INVENTION

The present invention is directed to a to a cranial support cushion (headrest) for retaining cabling for instruments that monitor the vital signs of patients. The headrest of the present invention is of particular importance to the field of anesthesia and or other patient settings.

Heretofore, patients were provided with one of several known pillow configurations that cushion the head and neck when the head of a person (patient) falls to the side or forward. For example, donut-shaped cushions have been used for a headrest, as have “U” shaped devices. Such headrests and cushions, however, do not conform well to the cranial and neck regions when the patient is lying supine or prone on a table or gurney. Known cable retaining devices include so-called plastic ‘zip-ties’ having a grooved strip with a locking mechanism to hold the plastic strip into various sized loops.

The prior art includes a donut shaped cushion used as an headrest, but the disclosed cushion does not includes any device for retaining cords for instruments. The disclosed cushion has a substantially uniform, rectangular cross-section that does not conform well to the cranial and neck regions of the patient. Also known in the prior art is a device configured to support the entire body or the upper torso of a patient, but is without any apparatus for retaining wires or connectors to instruments.

Another known pillow is configured for positioning around the neck to cushion the head and neck when a patient is asleep to prevent the head from falling forward or to the side. Another disclosed apparatus includes a toroidal cushion configured for preventing tilting movement of the head. None of the known prior art headrests include a device for retaining cables, cords, wires or other connectors to instruments in a hospital environment.

Accordingly, there is a need for, and what was heretofore unavailable, a headrest having a device for retaining instrumentation cabling. The present invention satisfies these and other needs.

### SUMMARY OF THE INVENTION

Briefly, and in general terms, the present invention is directed to an apparatus used on a table or gurney so as to preventing tilting movement of the head of a patient, for example, as a cranial support cushion or headrest during surgery or recovery from trauma. The cranial support cushion is further configured with one or more devices for retaining instrumentation cabling.

The present invention provides a headrest including a pillow (cushion) having a toroidal body with a top (first) surface that may be substantially smooth or flat for resting the head (cranium) of a patient. The headrest is configured with a bottom (second) surface that contacts the table or gurney supporting the patient in a prone position. One or more retaining devices are attached to the outer (third) surface of the pillow. When the pillow is toroidal (‘donut’ shaped) the outer surface is arcuate (curved, circular) in shape. Accordingly, the body of the pillow forms a cylinder having a hollow and cylindrical central portion. Alternatively, the pillow may be rectangular, square, quadrilateral, triangular (tetrahedral), box (hexahedron) or alternatively shaped for comfortably positioning the head of a patient.

Each retaining device is formed from a strip of material indentified by a first end (top, front) portion, a second end (bottom, back) portion and a central (middle) portion located between the end portions of the strip. The central portion of the retaining device is attached to the outer surface of the pillow. The ends of the retaining devices may be closed to form a loop so as to retain instrumentation cabling adjacent the headrest. Various materials, such as hook-and-loop strips (for example, VELCRO), may be used to secure the ends of the retaining devices together, allowing for easy separation of the ends of the retaining devices to remove the instrumentation cabling. The material used to removably attach the ends of the retaining device should be chosen to avoid leaving a residue on the instrumentation cabling that is conducive to retaining blood and pathogens. The retaining devices may be permanently or removably attached the outside surface of the headrest by using glue, hook-and-loop strips or other devices compatible with the material used to form the pillow and suitable for the operating room or other environment in which the headrest is used.

The present invention contemplates a method of making a headrest, including providing a toroidal pillow. The method of making the present invention further includes providing one or more retaining devices configured with first and second end portions. A central portion of each retaining device is attached to the outside surface of the pillow.

The present invention also includes a method of using a headrest. In use, a central portion of one or more retaining devices is attached to an outside surface of a pillow having a toroidal shaped body. The top of the pillow is used for resting the head of a patient, and the bottom of the pillow lies flat (horizontal) on the table supporting the patient. A first end portion and a second end portion of each retaining device are configured for being removably attached together. Instrumentation cabling is positioned and secured within each retaining device by closing (attaching) the end portions. The cabling is removed from the headrest by opening (detaching) the ends of the retaining devices.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is a pictorial view of a headrest of the present invention positioned proximate a patient in an operating room having instrumentation and associated cabling.

FIG. 2 is a front perspective view of a headrest of the present invention positioned on a table with instrumentation cabling.

FIG. 3 is a cross-sectional view (see FIG. 4) of a headrest of the present invention showing a retaining device attached to the headrest and in an open position.

FIG. 4 is a cross-sectional view of a headrest of the present invention taken along line 4-4 of FIG. 2, having a retaining device in a closed position and positioned around instrumentation cabling.

FIG. 5 is a cross-sectional view of a headrest having a retaining device detached from a headrest in accordance with an alternative embodiment of the present invention.

### DETAILED DESCRIPTION OF THE INVENTION

As shown in the drawings for purposes of illustration, the present invention is an apparatus configured as a cranial support cushion (headrest) having one or more devices for retaining cables, wires or connectors (cabling) to instruments (instrumentation). The present invention is further directed to preventing tilting movement of the patient's head (for example, during surgery, or recovery from trauma) while isolating instrumentation cabling from a patient.

As used herein, the terms “cranial support cushion” and “headrest” include, but are not limited to, pillows, cushions, stabilizers, bolsters, ‘donuts’ or a suitable apparatus to be positioned near, on or under (proximate) a patient. Herein, the singular includes the plural and the grammatical articles “or “and” may be conjunctive.

As used herein, the term “cabling” includes, but is not limited to, one or more co-axial cables, fiber optic cables, twisted pair metal (for example, insulated copper) wires (wiring), alternating or direct current couplings, sensor leads and patient auxiliary monitoring devices.

As used herein, the term “instrumentation” includes, but is not limited to, medical instruments, diagnostic devices, vital sign monitors (for example, temperature monitors, pulse oximeters) and electronic machines of any kind having cabling that may be connected to a patient. Such instrumentation may be invasive or non-invasive relative to the patient.

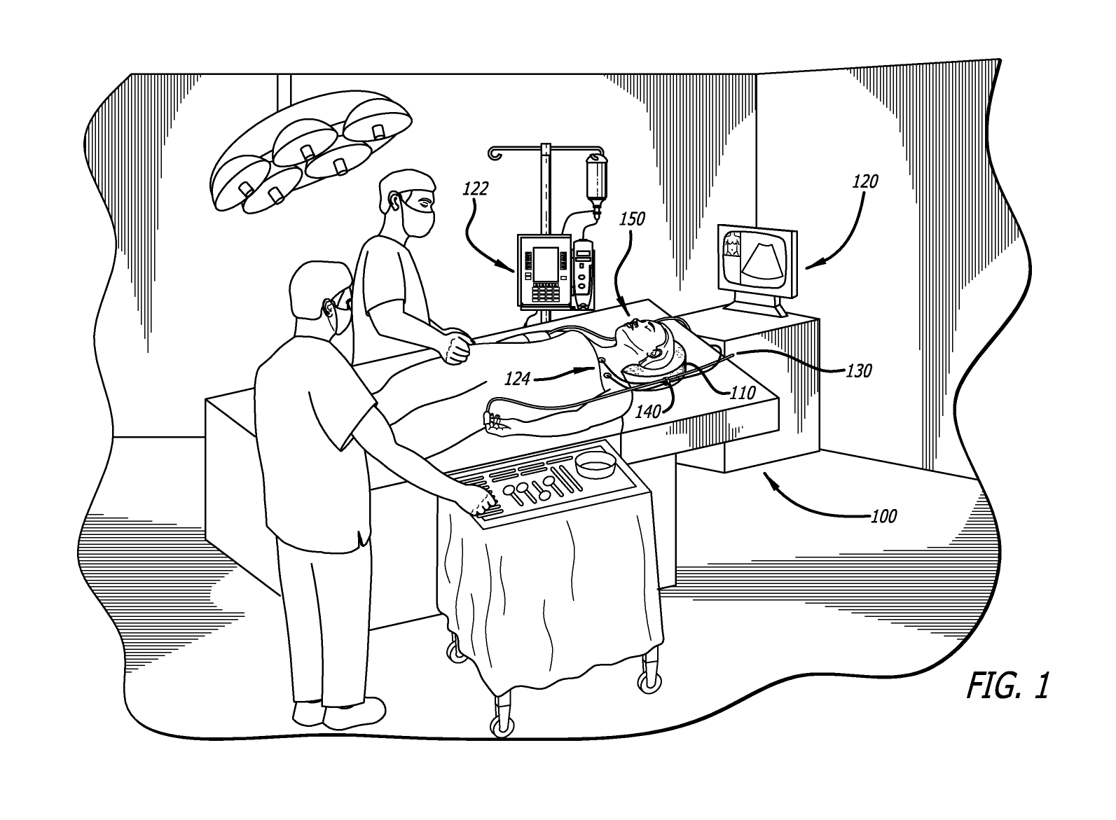

Turning now to the drawings, in which like reference numerals represent like or corresponding aspects of the drawings, and with particular reference to FIG. 1, a headrest 100 of the present invention is shown in a typical environment for using the present invention. The headrest includes a pillow 110 configured to be positioned proximate a patient 150, and preferably below the head of the patient. The patient is positioned (for example, supine or prone) on an operating (surgical) table or patient gurney 160. The headrest of the present invention is configured for use in an operating room or patient monitoring setting (arena) having instrumentation 120, 122, 124 and associated cabling 130. The headrest is further configured with one or more retaining devices 140 removably or permanently attached to the pillow in accordance with the present invention. The headrest may be particularly designed for organizing the cabling leading from or to instrumentation used by an anesthesiologist or other healthcare provider.

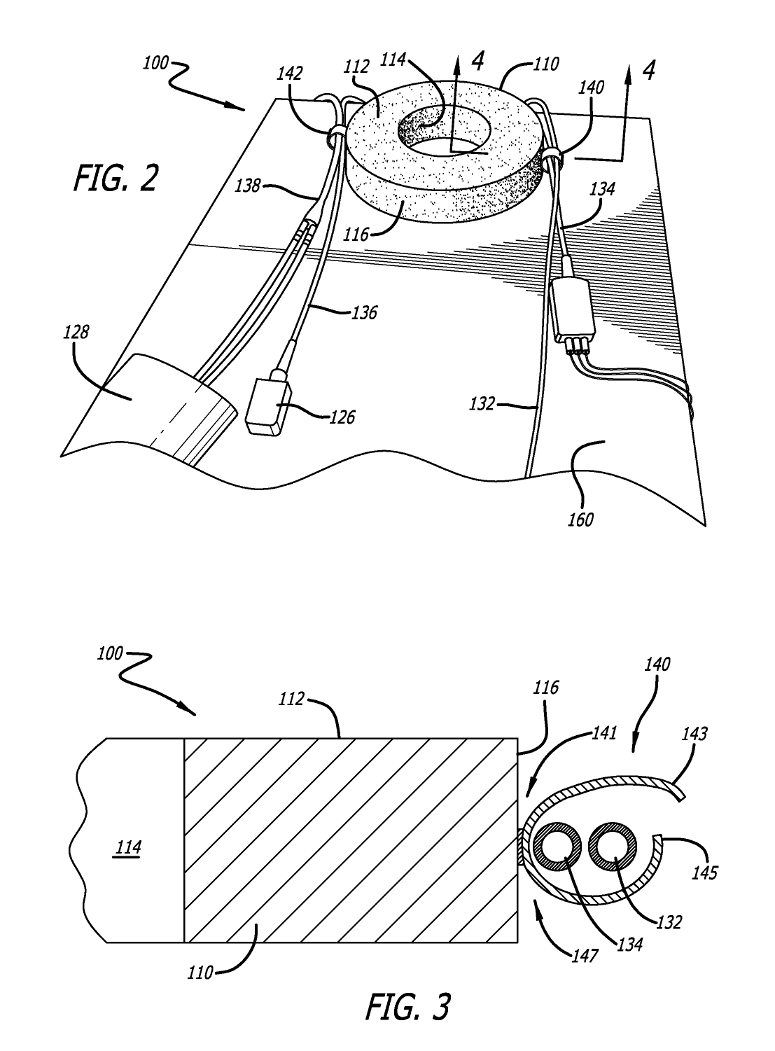

As shown in FIG. 2, the headrest 100 may be configured with a pillow (cushion) 110 on a platform 160 (for example, an operating table) with instrumentation cabling 132, 134, 136, 138. The cabling is connected on one end to monitoring or other instruments (see FIG. 1) and connected on the other end to medical devices 126, 128, such as pulse oximeters, temperature monitors and blood pressure cuffs for invasive or noninvasive monitoring. The headrest further includes at least one retaining device 140, 142 configured for organizing the cabling on the platform and away from a patient (see FIG. 1). The bottom surface of the pillow is substantially flat (smooth) so as to lie level (horizontal) on a table or other surface, such as an operating room gurney 160. As used herein, the term “substantially” is used so as to distinguish from “entirely” or “completely” such that a “substantially flat surface” may have indentations, irregularities, defects or purposed grating or texture without departing form the intended use of the surface. For example, a substantially flat bottom surface of the headrest pillow is intended to maintain contact with the horizontal surface of the table upon which the headrest is positioned. Similarly, a substantially flat top surface of a foam pillow may have some contours or indentation facilitating the comfortable positioning of a human head.

Further referring to FIG. 2, the pillow 110 may have a toroidal (‘donut’) or other suitable shape for conforming to the head of a human patient (use with other animals is contemplated, such as in a veterinary hospital). In an embodiment of the present invention, the pillow has a substantially circular and flat (smooth) upper surface 112 for supporting the perimeter of the patient's head and a circular cut-out or indentation 114 for stabilizing the back of the patient's cranium. The diameter, thickness and shape of the pillow may be varied to accommodate different patent sizes and types, for example, adults, adolescents and children. Suitable pillow diameters and for adult patients may be in the range of, but not limited to, fifteen to sixty centimeters. The pillow is further configured with an outer surface 116 for attaching the retaining devices 140, 142. The pillow thickness may vary with the type of material used to form the pillow, for example, about one centimeter to fifteen centimeters. The present invention contemplates that a plurality of pillows and headrests may be shacked vertically beneath the head of the patient for comfort and retaining the cabling away from the patient.

Referring now to FIG. 3, one embodiment of the headrest 100 of the present invention includes a pillow 110 configured with a top surface 112 and a central hollow portion 114, for example, a toroidal shape. The pillow may be configured as a cylinder having a hollow and cylindrical central portion within the body of the pillow. The central cutout (hollow middle portion) extends from the top surface to the bottom surface of the pillow. The outside surface of the pillow may be arcuate shaped (circular) and may extend from the bottom surface to the top surface to form a cylinder shape. The term toroid refers to such a cylinder with a hollow and circular shaped middle portion in the body of the pillow.

Referring further to FIG. 3, the headrest 100 is configured with one or more cable retaining devices 140 attached to the outer surface 116 of the pillow 110. The retaining device may be fixed (or removably attached) to the outer surface of the pillow by glue 141, sonic welding or other techniques compatible with the materials used to construct the pillow and the retaining device. The retaining device has a first end portion 143 that may be removably secured (connected) to a second end portion 145 of the retaining device. The retaining device is attached to the pillow at a center portion 147 between the two ends of the retaining device. In accordance with the intended use of the present invention, the first and second end portions of the retaining device are positioned (wrapped) around instrumentation cabling 132, 134. The end portions may be secured (attached) together using suitable fasteners and materials, such as, but not limited to, hook-and-eye apparatus, hook-and-loop material, buckles, snaps or non-permanent adhesives that will not leave a residue that with enhance contamination of the environment.

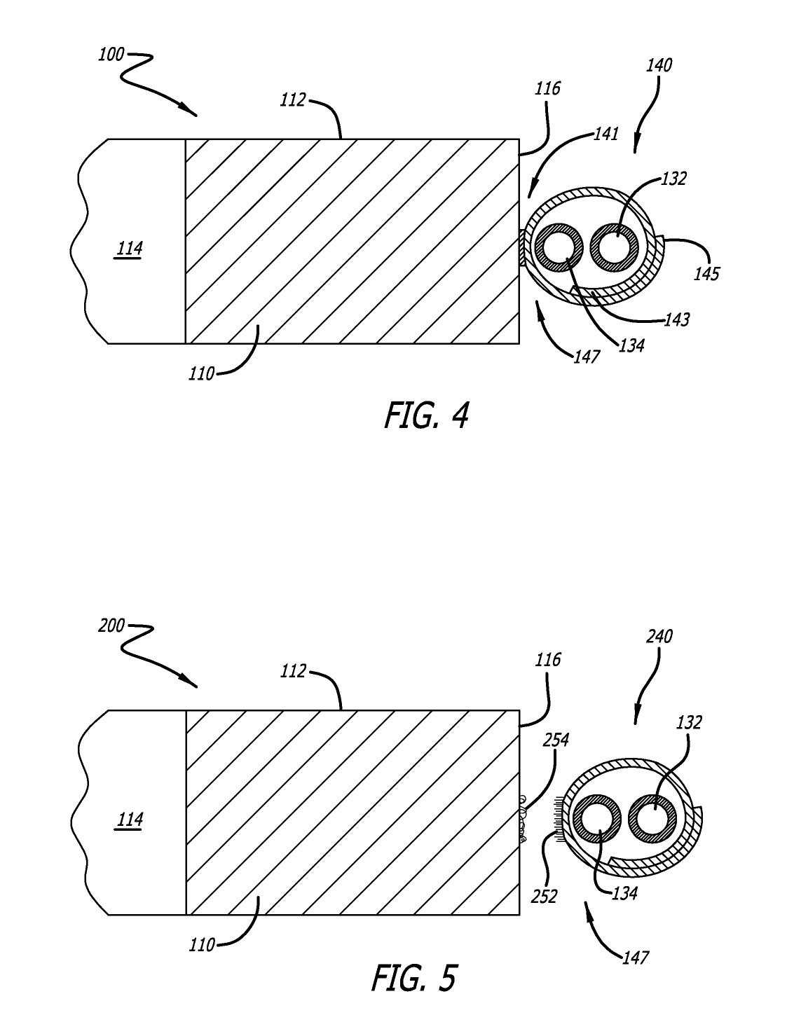

So as to facilitate containing cabling 132, 134 having different diameters and lengths, the end portions of the retaining device 140 may be moved from an open to a closed position (see FIG. 4). For example, the retaining device may be opened by separating the first end portion 143 from the second end portion 145 by applying torque, lifting motion or separating force to the end portions of the retaining device. Similarly, pressing the end portions of the retaining device together and around the cabling will close the retaining device and secure the cabling to the pillow 110 of the headrest 100. Such a retaining device may be configured from a strip of ‘hook-and-loop’ (‘burr’ or ‘touch’) fasteners, such as sold under the trade name VELCRO by American Velcro, Inc. of N.H., USA.

As shown in FIG. 5, an alternative embodiment of the headrest 200 of the present invention includes at least one retaining device 240 configured to be removably attached to a headrest pillow (cushion) 110 having a top surface 112 and a central hollow portion 114. For example, the central portion 147 of the retaining device may be attached to the outer surface 116 of the headrest by a strip of ‘hook-and-loop’ fastener. Accordingly, the retaining device may be detached from the headrest by applying a separating force to the retaining device while holding the pillow in place. Other mechanisms for removably attaching the retaining device to the pillow may be used and are within the scope of the present invention.

The materials used for construction of the headrest may vary in accordance with the use of the pillow and retaining device. Those skilled in the art of manufacturing medical devices can determine, without undue experimentation, the appropriate geometries, materials and other features of the headrest. For example, the pillow may be formed from a non-flammable, non latex product, such as foams and thermoplastics. Suitable materials for the pillow include, but are not limited to, polystyrene, polyurethane, polyesters (for example, polyethylene terephthalate—PET), Nylon and other polymers manufactured with flame retardant properties. Each retaining device—may be formed from a suitable material that will not interfere with the electronic signals in the cabling and instrumentation, for example, but not limited to, rubber (non-latex), plastic or other synthetic, hypoallergenic material. Configuration of the material for the retaining device must also consider the use in the intended environment, such as having properties to limit transfer of blood and pathogens.

While particular forms of the invention have been illustrated and described with regard to certain embodiments of the headrest, it will also be apparent to those skilled in the art that various modifications can be made without departing from the scope of the invention. More specifically, it should be understood that the present invention is not limited to any particular materials or methods of manufacturing the disclosed pillow and retaining device. Accordingly, it is not intended that the invention be limited beyond the intended scope of the invention, for example, but not limited to, the appended claims.

I claim:

1. A cranial support cushion, comprising:
a pillow having a body, a first surface, a second surface and a third surface; and
a first retaining device attached to the third surface of the pillow.

2. The cranial support cushion of claim 1, wherein the body of the pillow is configured as a toroid, having a flat second surface; and
wherein the third surface is arcuate in shape and is configured between the first surface and the second surface.

3. The cranial support cushion of claim 1, wherein the body of the pillow is configured as a cylinder having a hollow and cylindrical central portion within the body and extending from the first surface to the second surface;
wherein the first surface is substantially smooth;
wherein the second surface is substantially smooth; and
wherein the third surface is arcuate in shape and is configured between the first surface and the second surface.

4. The cranial support cushion of claim 3, wherein the first retaining device includes a first end portion, a second end portion and central portion located between the first end portion and the second end portion; and
wherein the central portion of the first retaining device is attached to the third surface of the pillow.

5. The cranial support cushion of claim 4, wherein the first retaining device includes means for removably attaching the first end portion to the second end portion.

6. The cranial support cushion of claim 5, wherein the means for removably attaching is formed from hook-and-loop material.

7. The cranial support cushion of claim 5, further comprising a second retaining device having a first end portion, a second end portion and central portion located between the first end portion of the second retaining device and the second end portion of the second retaining device;
wherein the central portion of the second retaining device is attached to the third surface of the pillow; and
wherein the second retaining device includes means for removably attaching the first end portion of the second retaining device to the second end portion of the second retaining device.

8. The cranial support cushion of claim 7, wherein the means for removably attaching the first end portion of the first retaining device to the second end portion of the first retaining device is formed from hook-and-loop material, and wherein the means for removably attaching the first end portion of the second retaining device to the second end portion of the second retaining device is formed from hook-and-loop material.

9. The cranial support cushion of claim 5, wherein the headrest further includes means for removably attaching the first retaining device to the third surface of the pillow.

10. A method of making a cranial support cushion, comprising:
providing a pillow having a body, a top surface, a bottom surface and an outside surface, wherein the body of the pillow is configured as a toroid; and
providing a first retaining device configured with a first end portion, a second end portion and a central portion located between the first end portion and the second end portion; and
attaching the central portion of the first retaining device to the outside surface of the pillow.

11. The method of claim 10, wherein providing the first retaining device includes providing means for removably attaching the first end portion to the second end portion.

12. The method of claim 11, further comprising providing a second retaining device having a second end portion, a second end portion and central portion located between the first end portion of the second retaining device and the second end portion of the second retaining device; and
providing means for removably attaching the first end portion of the second retaining device to the second end portion of the second retaining device; and
attaching the central portion of the second retaining device to the third surface of the pillow.

13. A method of using a cranial support cushion, comprising:
attaching a central portion of a first retaining device to an outside surface of a pillow having a toroidal shaped body,
wherein the body of the pillow is formed with a top surface and a flat bottom surface,
wherein the central portion the first retaining device is configured between a first end portion and a second end portion, and
wherein the first retaining device includes means for removably attaching the first end portion to the second end portion; and
securing a first instrumentation cabling within the first retaining device by removably attaching the first end portion to the second end portion.

14. The method of claim 13, further comprising attaching a central portion of a second retaining device to the third surface of the pillow,
wherein the central portion the second retaining device is configured between a first end portion of the second retaining device and a second end portion of a second retaining device, and
wherein the second retaining device includes means for removably attaching the first end portion of the second end retaining device to the second end portion of the second retaining device; and
securing a second instrumentation cabling within the second retaining device by removably attaching the first end portion of the second retaining device to the second end portion of the second retaining device.

15. The method of claim 14, wherein removably securing a first instrumentation cabling includes using hook-and-loop material to attach the first end portion of the first retaining device to the second end portion of the first retaining device; and
wherein removably securing a second instrumentation cabling includes using hook-and-loop material to attach the first end portion of the second retaining device to the second end portion of the second retaining device.
